(19) United States
(12) Patent Application Publication
(10) Pub. No.: US 2025/0336204 A1
(43) Pub. Date: Oct. 30, 2025

(54) METHOD OF DETECTING VIDEO ANOMALY ON BASIS OF MULTIMODAL DIFFUSION AND DEVICE THEREFOR

(71) Applicant: UIF (University Industry Foundation), Yonsei University, Seoul (KR)

(72) Inventors: Sanghyun PARK, Seoul (KR); Kijung LEE, Seoul (KR); Youngwan JO, Seoul (KR); Sunghyun AHN, Seoul (KR)

(21) Appl. No.: 19/078,589

(22) Filed: Mar. 13, 2025

(30) Foreign Application Priority Data
Apr. 25, 2024 (KR) 10-2024-0055081

(51) Int. Cl. G06V 10/98; G06T 5/70; G06T 5/73; G06V 10/77; G06V 10/82; G06V 20/40; G06V 20/70

(52) U.S. Cl. CPC G06V 10/993; G06T 5/70; G06T 5/73; G06V 10/7715; G06V 10/82; G06V 20/46; G06V 20/70

(57) ABSTRACT

Proposed are a method of detecting a video anomaly on the basis of multimodal diffusion, and the method includes a step of obtaining video data including a plurality of frames, a step of detecting an object included in each of the plurality of frames, a step of extracting a multimodal feature vector including a visual feature vector, a text feature vector, and a motion feature vector for the detected object, a step of generating a noise vector by injecting noise into the visual feature vector, a step of generating a restoration vector with the noise removed by inputting the noise vector into a diffusion model and by using the text feature vector and the motion feature vector as conditions, and a step of performing anomaly detection on the video data by comparing the visual feature vector and the restoration vector.

### CROSS REFERENCE TO RELATED APPLICATION

The present application claims priority to Korean Patent Application No. 10-2024-0055081, filed Apr. 25, 2024, the entire contents of which are incorporated herein for all purposes by this reference.

### STATEMENT REGARDING GOVERNMENT SPONSORED RESEARCH OR DEVELOPMENT

The present disclosure was developed in the task of a project (Project identification number: 1711198526, Project number: 00229822, Ministry name: Ministry of Science and ICT, Project management organization name: National Research Foundation of Korea, Research project name: Innovative New Drug Discovery Using Artificial Intelligence, Research Project Name: Development of an AI-based Multi-drug Indication Optimization Platform and Innovative New Drug Discovery for Overcoming Intractable Diseases, Project implementation organization name: Yonsei University, Research period: 2024.01.01-2024.12.31.)

Meanwhile, in all the aspects of the inventive concept, there is no property interest in the government of the Republic of Korea.

### BACKGROUND

### Field of the Invention

The present disclosure relates to a method of detecting a video anomaly on the basis of multimodal diffusion and a device therefor and, more particularly, to a method of detecting a video anomaly by using a plurality of features and a device therefor.

### Description of the Related Art

Recently, with the development of technologies such as artificial intelligence (AI), various technologies are being developed to recognize abnormal behaviors related to the occurrence of safety accidents, etc. through images collected from surveillance cameras such as CCTV. For example, AI models are being trained and developed to distinguish between images captured in normal conditions and images captured when abnormal behaviors occur. However, since the occurrence frequency of abnormal behaviors is low, it is difficult to secure sufficient image data for training such AI models. In addition, most current models may only utilize fragmentary information such as frame images, resulting in low accuracy.

### SUMMARY

An objective of the present disclosure for solving the problem described above is to provide: a method of detecting a video anomaly on the basis of multimodal diffusion; a computer program stored in a computer-readable medium; the computer-readable medium stored with the computer program; and a device (a system) therefor.

According to an exemplary embodiment of the present disclosure, there is provided a method of detecting a video anomaly on the basis of multimodal diffusion and being performed by at least one processor, the method including: obtaining video data including a plurality of frames; detecting an object included in each of the plurality of frames; extracting a multimodal feature vector including a visual feature vector, a text feature vector, and a motion feature vector for the detected object; generating a noise vector by injecting noise into the visual feature vector; generating a restoration vector with the noise removed by inputting the noise vector into a diffusion model and using the text feature vector and the motion feature vector as conditions; and performing anomaly detection on the video data by comparing the visual feature vector and the restoration vector.

According to the exemplary embodiment of the present disclosure, the extracting of the multimodal feature vector may include extracting the visual feature vector for the object by providing information related to the detected object to a trained model based on Inflated 3D ConvNet (I3D).

According to the exemplary embodiment of the present disclosure, the extracting of the multimodal feature vector may include generating a caption for describing the object by providing information related to the detected object to a model based on Bidirectional Encoder Representations from Transformers (BERT); and extracting the text feature vector corresponding to the description of the object by providing the generated caption to a trained model based on Simple Contrastive Learning of Sentence Embeddings (SimCSE).

According to the exemplary embodiment of the present disclosure, the extracting of the multimodal feature vector may include extracting skeletal information corresponding to the object by providing information related to the detected object to a trained model based on High-Resolution Network (HRNet); and extracting the motion feature vector representing motion of the object by using the extracted skeletal information.

According to the exemplary embodiment of the present disclosure, the extracting of the motion feature vector representing the motion of the object by using the extracted skeletal information may include extracting the motion feature vector by providing the extracted skeletal information to a trained model based on PoseConv3D.

According to the exemplary embodiment of the present disclosure, the generating of the noise vector by injecting the noise into the visual feature vector may include generating the noise vector by injecting an amount of Gaussian noise determined according to a range of a time step into the visual feature vector.

According to the exemplary embodiment of the present disclosure, the diffusion model may include a first diffusion model and a second diffusion model, and the generating of the restoration vector with the noise removed may include a first restoration step of inputting the noise vector into the first diffusion model and removing at least some of the noise included in the noise vector by using the text feature vector as a condition; and a second restoration step of inputting a noise vector into the second diffusion model and removing at least some of the noise included in the noise vector by using the motion feature vector as a condition.

According to the exemplary embodiment of the present disclosure, the generating of the restoration vector with the noise removed may further include generating the restoration vector with the noise removed by iteratively performing the first restoration step and the second restoration step.

According to the exemplary embodiment of the present disclosure, the performing of the anomaly detection on the video data may include calculating an anomaly score based on a distance between the visual feature vector and the restoration vector; and performing the anomaly detection on the video data on the basis of whether the calculated anomaly score is greater than or equal to a threshold value.

According to the exemplary embodiment of the present disclosure, the calculating of the anomaly scow may include calculating the anomaly score according to the distance by using a mean square error (MSE) between the visual feature vector and the restoration vector.

According to the exemplary embodiment of the present disclosure, the diffusion model may include an encoder including a plurality of denoising attention blocks (DABs); a bottleneck; and a decoder.

According to the exemplary embodiment of the present disclosure, each denoising attention block may include a residual block including a plurality of linear layers connected by skip connection; and a transformer block including a self-attention layer, a cross-attention layer, and a feed-forward network (FFN).

There is provided a computer program stored in a computer-readable recording medium to execute a method, on a computer, described according to the exemplary embodiment of the present disclosure.

According to the exemplary embodiment of the present disclosure, there is provided a computing device including: a communication module; a memory; and at least on processor connected to the memory and configured to execute at least one computer-readable program included in the memory, wherein the at least one program may include commands that obtain video data including a plurality of frames, detect an object included in each of the plurality of frames, extract a multimodal feature vector including a visual feature vector, a text feature vector, and a motion feature vector for the detected object, generate a noise vector by injecting noise into the visual feature vector, generate a restoration vector with the noise removed by inputting the noise vector into a diffusion model and using the text feature vector and the motion feature vector as conditions, and perform anomaly detection on the video data by comparing the visual feature vector and the restoration vector.

In various exemplary embodiments of the present disclosure, a computing device may enhance the performance of video anomaly detection by complementarily using a multimodal feature vector.

In the various exemplary embodiments of the present disclosure, by referring to a text feature vector and/or a motion feature vector as conditions when a transformer block and a residual block are calculated, a computing device may effectively perform noise removal and vector restoration by referring to both text describing an object and/or motion of the object together with visual features of the object.

In the various exemplary embodiments of the present disclosure, both a first diffusion model and a second diffusion model having respective conditions different from each other are used instead of using a single diffusion model, so that restoration performance may be improved, and thus video anomaly detection may be performed with higher accuracy.

### BRIEF DESCRIPTION OF THE DRAWINGS

The exemplary embodiments of the present disclosure will be described below with reference to the accompanying drawings, wherein similar reference numerals represent similar elements, but are not limited thereto.

FIG. 1 is a functional block diagram illustrating an internal configuration of a computing device according to exemplary embodiments of the present disclosure.

FIG. 2 is a block diagram illustrating a process of extracting a multimodal feature vector according to the exemplary embodiments of the present disclosure.

FIG. 3 is an exemplary view illustrating a structure of a diffusion model according to the exemplary embodiments of the present disclosure.

FIG. 4 is an exemplary view illustrating a structure of a denoising attention block according to the exemplary embodiments of the present disclosure.

FIG. 5 is a view illustrating an example in which a restoration process is performed by a first diffusion model and a second diffusion model according to an exemplary embodiment of the present disclosure.

FIG. 6 is a view illustrating an example in which a restoration process is performed by a first diffusion model and a second diffusion model according to a second exemplary embodiment of the present disclosure.

FIG. 7 is a view illustrating an example in which a restoration process is performed by a first diffusion model and a second diffusion model according to a third exemplary embodiment of the present disclosure.

FIG. 8 is a view illustrating an example in which a restoration process is performed by a first diffusion model and a second diffusion model according to a fourth exemplary embodiment of the present disclosure.

FIG. 9 is a flowchart illustrating an example of a method of detecting a video anomaly on the basis of multimodal diffusion according to the exemplary embodiments of the present disclosure.

FIG. 10 is a block diagram illustrating a hardware configuration of the computing device according to the exemplary embodiments of the present disclosure.

### DETAILED DESCRIPTION OF EXEMPLARY EMBODIMENTS

Hereinafter, specific details for implementing an embodiment of the present disclosure will be described in detail with reference to the attached drawings. However, in the following description, when there is concern of unnecessarily obscuring the gist of the embodiment of the present disclosure, detailed descriptions of well-known functions or components will be omitted.

In the attached drawings, identical or corresponding components are given the same reference numerals. In addition, in the description of the exemplary embodiments below, redundant descriptions of identical or corresponding components may be omitted. However, even though a description of a component is omitted, this omission is not intended to imply that such a component is not included in any exemplary embodiments.

Advantages and features of the disclosed exemplary embodiments and the method of achieving the same will become apparent with reference to the exemplary embodiments described below in conjunction with the accompanying drawings. However, the present disclosure is not limited to the exemplary embodiments disclosed below, but may be implemented in various different forms. The present exemplary embodiments are provided only to make the present disclosure complete and to fully inform those skilled in the art of the scope of the present disclosure.

The terms used in the present specification will be briefly described, and then the exemplary embodiments of the present disclosure will be described in detail. The terms used in the present specification are the selected general terms that are currently used as widely used as possible while considering functions in the embodiments of the present disclosure, but this may vary according to the intention of those skilled in the art, the judicial precedent, the emergence of new technologies, etc. In addition, in certain cases, there are terms arbitrarily selected by the applicants, and in this case, the meaning of the terms will be described in detail in the description of the corresponding embodiments of the present disclosure. Therefore, the terms used in the present disclosure should be defined based on the meaning of the terms and the overall content of the present disclosure rather than based on simple names of the terms.

In the present specification, singular expressions include plural expressions unless the context clearly specifies that they are singular. In addition, the plural expressions include the singular expressions unless the context clearly specifies that they are plural. Throughout the description of the present specification, when a part is said to “include” or “comprise” a certain component, it means that it may further include or comprise other components, without excluding other components unless the context specifically states otherwise.

In the present disclosure, the terms “comprise,” “comprising,” and the like may indicate the presence of features, steps, operations, elements, and/or components, but such terms do not exclude the addition of one or more other functions, steps, operations, elements, components, and/or combinations thereof.

In the present disclosure, in a case when a particular component is referred to as being “coupled,” “combined,” “connected,” or “reacting” with any other component, the particular component may be directly coupled, combined, and/or connected to, or reacting with, another component, but is not limited thereto. For example, there may be one or more intermediate components between the particular component and another component. In addition, in the present disclosure, “and/or” may include each of one or more of listed items, or a combination of at least a portion of the one or more of the listed items.

In the present disclosure, terms such as “first,” “second,” etc. are used to distinguish a particular component from another component, and the components described by such terms are not limited thereto. For example, a “first” component may be an element of the same or similar form as a “second” component.

In the present disclosure, “video anomaly detection” may refer to detecting abnormal behavior and/or abnormal situations such as fights, robberies, arson, explosions, etc., by using images collected from surveillance cameras such as CCV.

In the present disclosure, “anomaly and/or abnormal behavior” refers to an abnormal behavior predefined by a user, and may include, for example, human action such as fighting, riding a bicycle on a sidewalk, disaster situations such as fire and explosion, and so on.

In the present disclosure, “multimodal” may refer to processing various types of data such as visual data and text data together.

In the present disclosure, a “diffusion model” may refer to a generative model that generates data through a process of gradually adding noise to the data or gradually restoring the data from the noise. For example, the diffusion model may include: a first diffusion model for using a text feature vector as a condition; and a second diffusion model for using a motion feature vector as a condition. Here, the first diffusion model and second diffusion model are trained separately during training, but may be used together during inference.

In the present disclosure, a “visual feature vector” may refer to a vector representing appearance information such as color and shape of an object, a “text feature vector” may refer to a vector representing text describing the object, and a “motion feature vector” may refer to a vector representing a motion of the object. In addition, in the present disclosure, a “noise vector” refers to a vector in which at least some noise is injected into the visual feature vector, and may include both a vector generated by a diffusion process and a vector that has not sufficiently passed through a diffusion model and thus still includes the remaining noise. In addition, in the present disclosure, a “restoration vector” may refer to a vector in a form in which all the noise injected into the visual feature vector is removed.

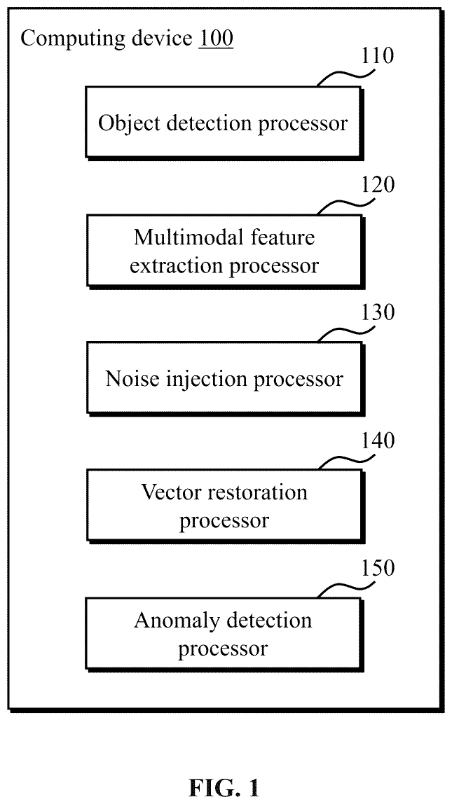

FIG. 1 is a functional block diagram illustrating an internal configuration of a computing device 100 according to the exemplary embodiments of the present disclosure. According to the exemplary embodiments, the computing device 100, as an arbitrary device for performing video anomaly detection, may include an object detection processor 110, a multimodal feature extraction processor 120, a noise injection processor 130, a vector restoration processor 140, an anomaly detection processor 150, and the like. For example, in a case of obtaining video data including a plurality of frames from a surveillance camera such as CCTV, the computing device 100 may detect whether an abnormal behavior occurs from the corresponding video data.

According to the exemplary embodiments, the computing device 100 may first detect an object included in each of a plurality of frames constituting the corresponding video data in order to detect whether the object included in the video data performs an abnormal behavior. For example, the object detection processor 110 may detect the object included in each of the plurality of frames through any object tracking algorithm (e.g., an object detector, a multi object tracker, etc.) and/or a machine learning model. In this case, an object tracklet as expressed in Equation 1 below may be extracted from the consecutive frames.

$${\{ {O}_{n} \vert {O}_{n} ∈ {ℝ}^{l \times 3 \times H \times W} \}}_{n = 1}^{N} \qquad [ Equation 1 ]$$

Here, Oₙ may indicate an object tracklet, N may indicate the number of objects, and L, H, and W may respectively indicate a length, height, and width of the object tracklet Here, the object tracklet may include an array representing movement over time of one identical object detected on the plurality of frames. That is, the object detection processor 110 may associate the same object extracted from each frame and detect the movement over time of the corresponding object.

According to the exemplary embodiments, the object detection processor 110 may convert the extracted frame-level object tracklet into a segment-level object tracklet. Here, a segment may consist of 16 consecutive frames, but is not limited thereto. In a case of converting the frame-level object tracklet into the segment-level object tracklet, the object tracklet may have a form of [symbol] ^{S×16×3×H×W} S=l/16. In this way, the segment-level object tracklet converted is information related to the detected object, and may be used as information for multimodal feature extraction.

According to the exemplary embodiments, the multimodal feature extraction processor 120 may extract a multimodal feature vector including a visual feature vector, a text feature vector, and a motion feature vector for the detected object. For example, the multimodal feature extraction processor 120 may extract a visual feature vector for the object by providing information related to the detected object to a trained model based on Inflated 3D ConvNet (I3D). Here, the I3D-based model may refer to a model for extracting visual information such as color and shape of the object.

Additionally, the multimodal feature extraction processor 120 may generate a caption for providing a description of the object by providing information related to the detected object to a model (e.g., a SwinBERT model) based on Bidirectional Encoder Representations from Transformers (BERT). Here, the caption is a text for describing the detected object. For example, in a case where an object tracklet of “A man riding a bicycle” is provided as input, a caption such as “A man is riding a bicycle with a bicycle on a street” may be extracted. In this case, the multimodal feature extraction processor 120 may extract a text feature vector corresponding to the description of the object by providing the generated caption to a trained model based on Simple Contrastive Learning of Sentence Embeddings (SimCSE).

Additionally, the multimodal feature extraction processor 120 may extract skeletal information corresponding to the object by providing information elated to the detected object to a trained model based on High Resolution Network (HRNet). Here, the skeletal information may be skeletal information generated by extracting key feature points of the object (e.g., joints of a human body, etc.) and connecting the extracted feature points. In this case, the multimodal feature extraction processor 120 may extract a motion feature vector representing motion of the object by providing the extracted skeletal information to a trained model based on PoseConv3D.

According to the exemplary embodiments, the computing device 100 may inject noise onto the visual feature vector in order to use the noise as input to a diffusion model. For example, the noise injection processor 130 may generate a noise vector by injecting an amount of Gaussian noise determined according to a range of a time step into the visual feature vector. The noise injection processor 130 may inject the noise into the visual feature vector on the basis of the following Equation 2 when the time step have a range of t∈[1, T].

$${f}_{vis}^{c} = \sqrt{{α}_{t}} {f}_{vis}^{0} + \sqrt{1 - {α}_{t}} ϵ , ϵ ∼ N ( 0 , l ) , {α}_{t} = {\prod }_{0}^{t} ( 1 - {β}_{t} ) \qquad [ Equation 2 ]$$

Here, fᵥᵢₛ⁰ indicates a visual feature vector, and fᵥᵢₛ^{t} may be a noise vector, i.e., a visual feature vector injected with noise for as long as a time step of t. In addition, βₜ may be a schedule used to determine an amount of noise to be injected. That is, as βₜ increases, αₜ decreases further, so more noise may be injected.

According to the exemplary embodiments, the vector restoration processor 140 may restore an original vector by inputting the noise vector generated by injecting the noise onto the visual feature vector into the diffusion model. For example, the vector restoration processor 140 may input the noise vector into the diffusion model and generate a restoration vector with the noise removed by using a text feature vector and a motion feature vector as conditions. Here, the conditions may refer to information referenced when the diffusion model operates, and the diffusion model may generate data by referencing the information input as the conditions.

According to the exemplary embodiments, the vector restoration processor 140 may generate the restoration vector having the noise removed by iteratively preforming restoration steps including: a first restoration step of inputting a noise vector into a first diffusion model and removing at least some of the noise included in the noise vector by using a text feature vector as a condition; and a second restoration step of inputting the noise vector into a second diffusion model and removing at least some of the noise included in the noise vector by using a motion feature vector as a condition.

According to the exemplary embodiments, the anomaly detection processor 150 may perform the anomaly detection on the video data by comparing the visual feature vector and the restoration vector. For example, the anomaly detection processor 150 may calculate an anomaly score based on a distance between the visual feature vector and the restoration vector, and perform the anomaly detection on the video data on the basis of whether the calculated anomaly score is greater than or equal to a threshold value. Here, the anomaly score according to the distance between the visual feature vector and the restoration vector may be calculated by using a mean squared error (MSE) as in the following Equation 3.

$$Loss = {‖ {f}_{vis}^{0} - {\hat{f}}_{vis}^{0} ‖}_{2}^{2} \qquad [ Equation 3 ]$$

Here, Loss may indicate a mean square error loss. In addition, fᵥᵢₛ⁰ may indicate an initial visual feature vector, and \hat{f}ᵥᵢₛ⁰ may indicate the restoration vector restored after the noise is removed by the diffusion model.

In FIG. 1, each functional component included in the computing device 100 is separately described, but this is only to help understand the present disclosure, and two or more functions may also be performed in one computing device. With such components, the computing device 100 may improve the performance of video anomaly detection by complementarily using a multimodal feature vector.

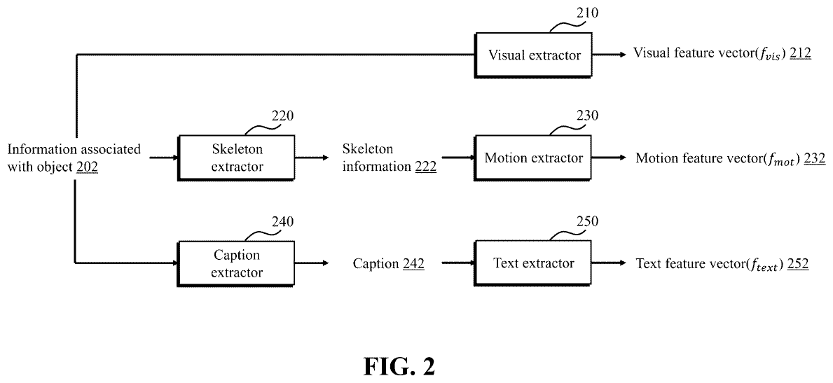

FIG. 2 is a block diagram illustrating a process of extracting a multimodal feature vector according to the exemplary embodiments of the present disclosure. As described above, the computing device 100 in FIG. 1 may detect an object in video data and extract a multimodal feature vector including a visual feature vector fᵥᵢₛ 212, a motion feature vector fₘₒₜ 232, and a text feature vector fₜₑₓₜ 252 for the detected object.

In a case where the object is detected in the video data, the multimodal feature vector may be extracted on the basis of information 202 associated with the detected object. Here, the information 202 associated with the object may represent an object tracklet. According to the exemplary embodiments, in a case where the information 202 associated with the object is input into a visual extractor 210, the visual feature vector fᵥᵢₛ 212 may be extracted. Here, the visual extractor 210 is a model configured to recognize and/or classify external information such as color and shape of the object, and may include an I3D-based model, a Convolutional 3D Network (C3D)-based model, etc. For example, the visual feature vector fᵥᵢₛ 212 may be extracted as in the following Equation 4.

$${f}_{vis} = {Φ}_{vis} ( {O}_{n} ) \qquad [ Equation 4 ]$$

According to the exemplary embodiments, skeleton information 222 corresponding to the object may be extracted in a case where the information 202 associated with the object is input into a skeleton extractor 220. Here, the skeleton extractor 220 may include a HRNet-based model for extracting the skeletal information of the object. Additionally, the motion feature vector fₘₒₜ 232 may be extracted in a case where the skeletal information 222 is input into a motion extractor 230. Here, the motion extractor 230 may include a PoseConv3D-based model and the like for estimating the pose and/or motion of the object on the basis of the skeletal information 222. For example, the motion feature vector fₘₒₜ 232 may be extracted as in the following Equation 5.

$${f}_{mot} = {Φ}_{mot} ( {Φ}_{skl} ( {O}_{n} ) ) \qquad [ Equation 5 ]$$

According to the exemplary embodiments, a caption 242 describing the motion of the object may be extracted in a case where the information 202 associated with the object is input into a caption extractor 240. Here, the caption extractor 240 may include a video captioning model such as a SwinBERT model. In addition, the text feature vector fₜₑₓₜ 252 may be extracted in a case where the caption 242 is input into a text extractor 250. Here, the text extractor 250 may include a model such as SimCSE for extracting sentence-based text features on the basis of the caption 242. For example, the text feature vector fₜₑₓₜ 252 may be extracted as in the following Equation 6.

$${f}_{text} = {Φ}_{text} ( {Φ}_{cap} ( {O}_{n} ) ) \qquad [ Equation 6 ]$$

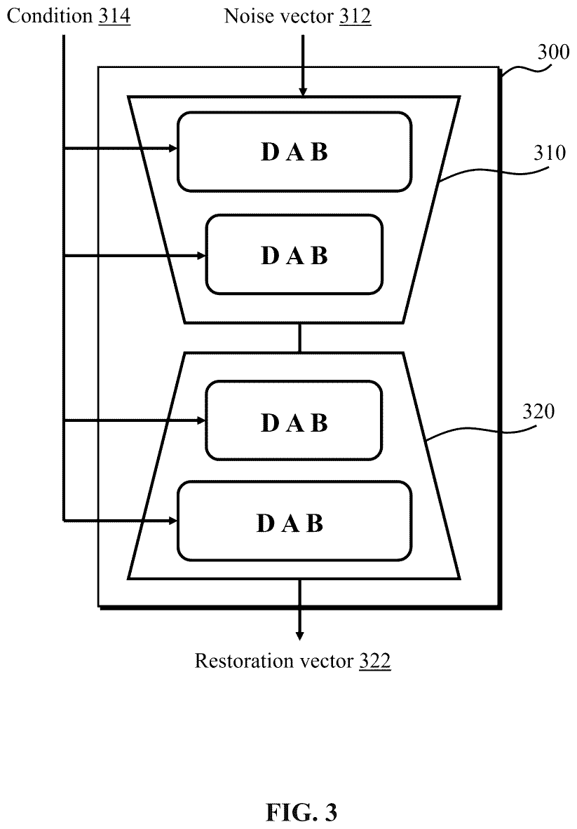

FIG. 3 is an exemplary view illustrating a structure of a diffusion model 300 according to the exemplary embodiments of the present disclosure. According to the exemplary embodiments, the diffusion model 300 may include an encoder 310 including a plurality of denoising attention blocks (DABs), a bottleneck (not shown), and a decoder 320. For example, the diffusion model 300 may generate a restoration vector 322 by removing noise injected into a noise vector 312 through the illustrated structure in FIG. 3.

According to the exemplary embodiments, the diffusion model 300 may generate the restoration vector 322 obtained by restoring the visual feature vector by taking the noise vector 312 as input and referencing the text feature vector or the motion feature vector as a condition 314. That is, when restoring the noise vector 312, the diffusion model 300 may generate the restoration vector 322 to be close to the right answer by referring to the text or motion corresponding to the object.

According to the exemplary embodiments, in a case where the noise vector 312 passes through the diffusion model 300, an amount of noise determined according to a time step may be removed. For example, in a case where the noise vector 312 passes through the diffusion model 300 once, the amount of noise corresponding to one time step may be removed. In another example, in a case where the noise vector 312 passes through the diffusion model 300 once, an amount of noise corresponding to half the time step may also be removed. That is, in a case where the noise vector 312 passes through the diffusion model 300 iteratively for as long as an interval of a time step given in a noise injection process, the restoration vector 322 with all the noise removed may be generated.

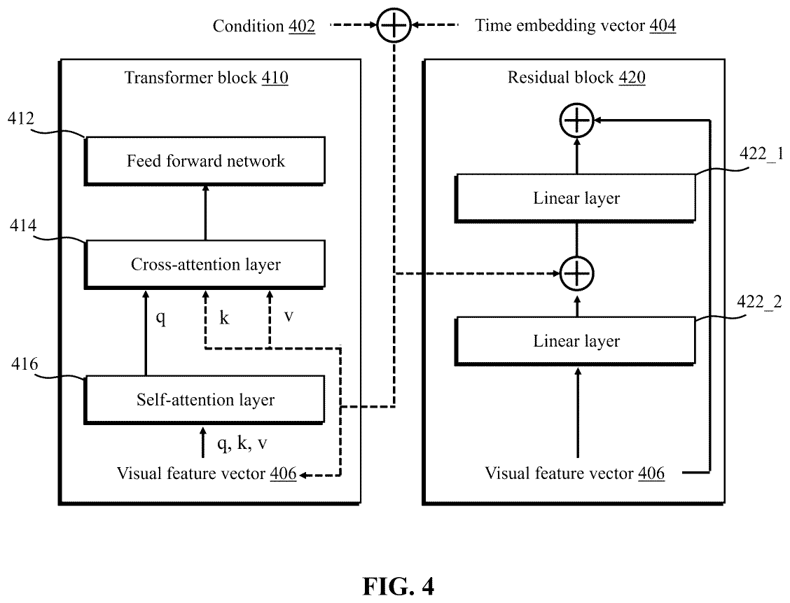

FIG. 4 is an exemplary view illustrating a structure of a denoising attention block according to the exemplary embodiments of the present disclosure. According to the exemplary embodiments, the denoising attention block may be composed of a stack of a transformer block 410 and a residual block 420. In addition, the transformer block 410 may include a self-attention layer 416, a cross-attention layer 414, and a feed forward network 412. The residual block 420 may include a plurality of linear layers 422_1 and 422_2 connected by skip connection.

According to the exemplary embodiments, since the diffusion model operates depending on a time step, a time embedding vector 404 may be combined with a condition 402, which is the text feature vector or the motion feature vector. For example, vector combination may be performed as in the following Equation 7.

$${f}_{cond}^{′} = {W}_{1} {f}_{cond} + {W}_{2} {f}_{ftime} \qquad [ Equation 7 ]$$

Here, f_{cond}′ may indicate a combined vector, f_{cond} may indicate the condition 402 which is the text feature vector or the motion feature vector, and f_{ftime} may indicate a time embedding vector 404. In addition, W₁∈ [symbol] ^{D}^{_{cond}}^{×D}^{ᵥᵢₛ} and W₂∈ [symbol] ^{D}^{ₜᵢₘₑ}^{×D}^{ᵥᵢₛ} may indicate projection matrices to respectively match a dimension D_{cond} of the condition 402 and a dimension Dₜᵢₘₑ of the time embedding vector 404 with a dimension Dᵥᵢₛ of an input visual feature vector 406. That is, the combined vector generated in this way may be provided to both of the transformer block 410 and the residual block 420 to help the diffusion model refer to the condition 402 more effectively.

According to the exemplary embodiments, the transformer block 410 may be a block for recognizing correlations between visual features and conditional features. To recognize these correlations, a segment-level multimodal feature vector may be converted into a clip-level multimodal feature vector. Here, a clip may be composed of a set of eight consecutive segments, but is not limited thereto. In this case, the clip-level multimodal feature vector may have a form [symbol] ^{C×8×d} C=S/16. For example, the transformer block 410 may perform a calculation as in the following Equation 8.

$$T A ( Q , K , V ) = Softmax ( \frac{Q {K}^{T}}{\sqrt{d}} ) V \qquad [ Equation 8 ]$$

Here, it may be that Q=W_{q}fᵥᵢₛ∈ [symbol] ^{C×8×d}, K=Wₖf_{cond}′∈ [symbol] ^{C×8×d}, V=Wᵥf_{cond}′∈ [symbol] ^{C×8×d}. In addition, W_{q}, Wₖ, Wᵥ [symbol] ^{D}^{ᵥᵢₛ}^{×d} may indicate respective projection matrices, and d may indicate a dimension of query, key, and value. As described above, by the text feature vector and/or motion feature vector referenced as the conditions 402 when the transformer block 410 and the residual block 420 are calculated, the computing device 100 in FIG. 1 may effectively perform noise removal and vector restoration by referring to both of the text for describing the object and/or the motion of the object together with the visual features of the object.

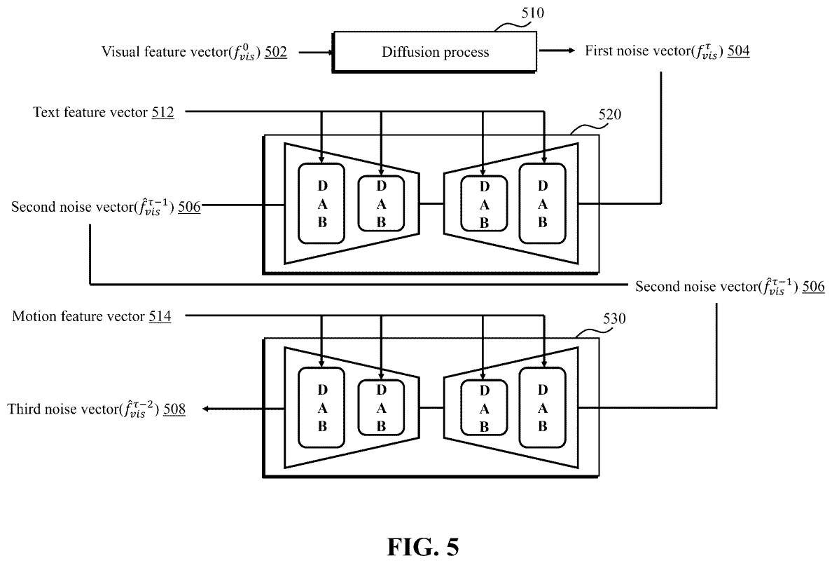

FIG. 5 is a view illustrating an example in which a restoration process is performed by a first diffusion model 520 and a second diffusion model 530 according to the exemplary embodiments of the present disclosure. As described above, the computing device 100 in FIG. 1 may input a noise vector into a diffusion model and generate a restoration vector with removed noise by using a text feature vector 512 and a motion feature vector 514 as conditions. Here, the diffusion model may include the first diffusion model 520 and the second diffusion model 530.

According to the exemplary embodiments, a first noise vector

$${f}_{vis}^{τ} 504$$

may be generated by a diffusion process 510 that injects noise into a visual feature vector

$${f}_{vis}^{0} 502 .$$

For example, in a case where a time step is set to τ, an amount of Gaussian noise corresponding to the time step τ may be injected into the visual feature vector

$${f}_{vis}^{0} 502$$

to generate the first noise vector

$${f}_{vis}^{τ} 504 .$$

According to the exemplary embodiments, the first noise vector

$${f}_{vis}^{τ} 504$$

generated in this way may be input to the first diffusion model 520 trained with the text feature vector 512 as a condition. In this case, the first diffusion model 520 may generate a second noise vector

$${\hat{f}}_{vis}^{τ - 1} 506$$

by removing noise once with reference to the text feature vector 512. Then, the generated second noise vector

$${\hat{f}}_{vis}^{τ - 1} 506$$

may be input to the second diffusion model 530 trained with the motion feature vector 514 as a condition. In this case, the second diffusion model 530 may generate a third noise vector

$${\hat{f}}_{vis}^{τ - 2} 508$$

by removing noise once again with reference to the motion feature vector 514.

In this case, the generated third noise vector

$${\hat{f}}_{vis}^{τ - 2} 508$$

is again provided to the first diffusion model 520, so that a cycle may be formed between the first diffusion model 520 and the second diffusion model 530. Through the above-described process, the restoration vector may be generated as a result that the noise is iteratively removed for as long as the time step r. With such a configuration, both of the first diffusion model 520 and the second diffusion model 530 with respective conditions different from each other are used instead of using a single diffusion model, so that the restoration performance may be improved, whereby the video anomaly detection may be performed with higher accuracy.

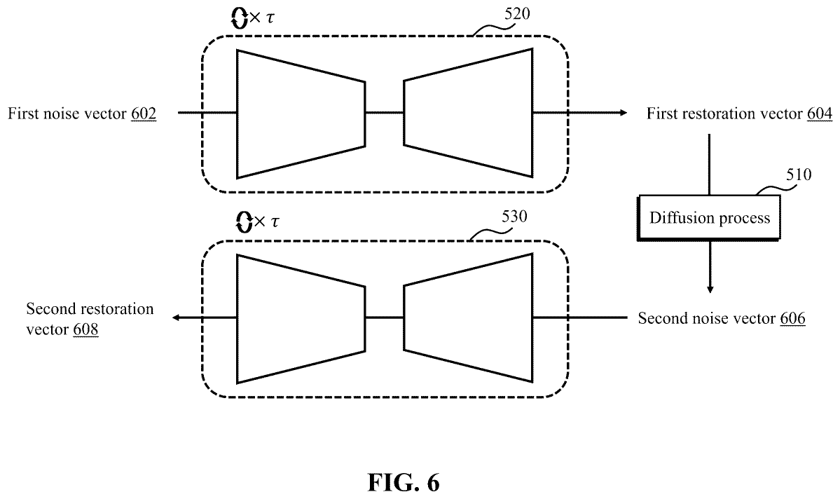

FIG. 6 is a view illustrating an example in which a restoration process is performed by a first diffusion model 520 and a second diffusion model 530 according to a second exemplary embodiment of the present disclosure. Unlike the restoration process described above, the order and/or method of using the first diffusion model 520 and the second diffusion model 530 may be determined differently. In the example in FIG. 6, the amount of Gaussian noise corresponding to a time step r is injected into a visual feature vector, whereby a first noise vector 602 may be generated. In this case, the first noise vector 602 may be iteratively input into the first diffusion model 520 for as long as the time step r, and accordingly, the first diffusion model 520 may generate a first restoration vector 604 with all the noise removed.

Then, the diffusion process 510 for the first restoration vector 604 may be performed again. For example, the amount of Gaussian noise corresponding to the time step r is injected into the first restoration vector 604 so that a second noise vector 606 may be generated. In this case, the second noise vector 606 may be iteratively input into the second diffusion model 530 for as long as the time step τ, and accordingly, the second diffusion model 530 may generate a second restoration vector 608 with all the noise removed.

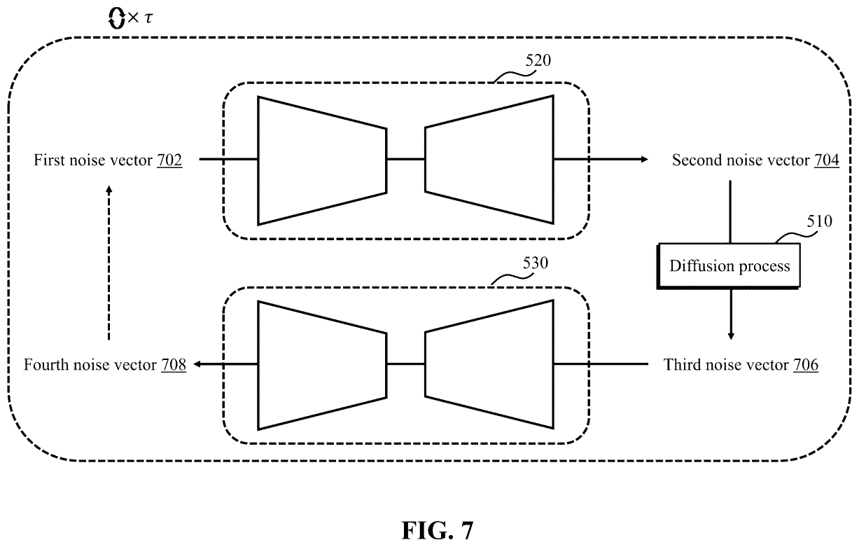

FIG. 7 is a view illustrating an example in which a restoration process is performed by a first diffusion model 520 and a second diffusion model 530 according to a third exemplary embodiment of the present disclosure. Unlike the restoration process described above, the order and/or method of using the first diffusion model 520 and the second diffusion model 530 may be determined differently. In the example in FIG. 7, an amount of Gaussian noise corresponding to a time step τ may be injected into a visual feature vector, so as to generate a first noise vector 702. In this case, the first noise vector 602 may be provided to the first diffusion model 520, and accordingly, the first diffusion model 520 may generate a second noise vector 704 from which the noise has been removed once.

According to the exemplary embodiments, the diffusion process 510 that injects noise for as long as one time step to the second noise vector 704 again may be performed, so as to generate a third noise vector 706. In this case, the third noise vector 706 may be provided to the second diffusion model 530, and accordingly, the second diffusion model 530 may generate a fourth noise vector 708 from which noise is removed once again. That is, the noise may be removed once each time the first diffusion model 520 and the second diffusion model 530 are cycled, and a restoration vector may be generated in a case of performing the corresponding cycle repeatedly for as long as the time step τ.

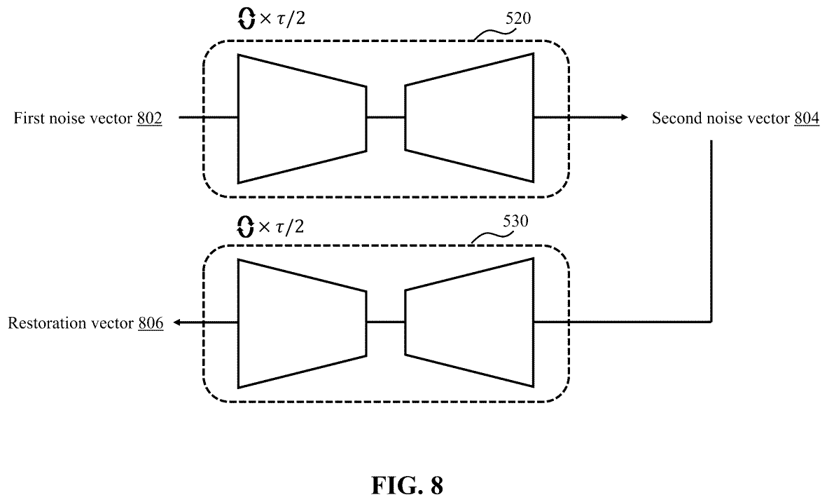

FIG. 8 is a view illustrating an example in which a restoration process is performed by a first diffusion model 520 and a second diffusion model 530 according to a fourth exemplary embodiment of the present disclosure. Unlike the restoration processes described above, the order and/or method of using the first diffusion model 520 and the second diffusion model 530 may be determined differently. In the example in FIG. 8, an amount of Gaussian noise corresponding to a time step τ may be injected into a visual feature vector to generate a first noise vector 802. In this case, the first noise vector 802 may be iteratively input into the first diffusion model 520 for as long as half the time step τ, and accordingly, the first diffusion model 520 may generate a second noise vector 804 with half the noise removed.

Then, the second noise vector 804 may be iteratively input into the second diffusion model 530 for as long as half the time step τ, and accordingly, the second diffusion model 530 may generate a restoration vector 806 with all the noise removed. As described above in FIGS. 5 to 8, the method of using the first diffusion model 520 and the second diffusion model 530 may be determined in various ways, and a restoration process may be performed to have optimal performance depending on the detection conditions of abnormalities and/or abnormal behaviors.

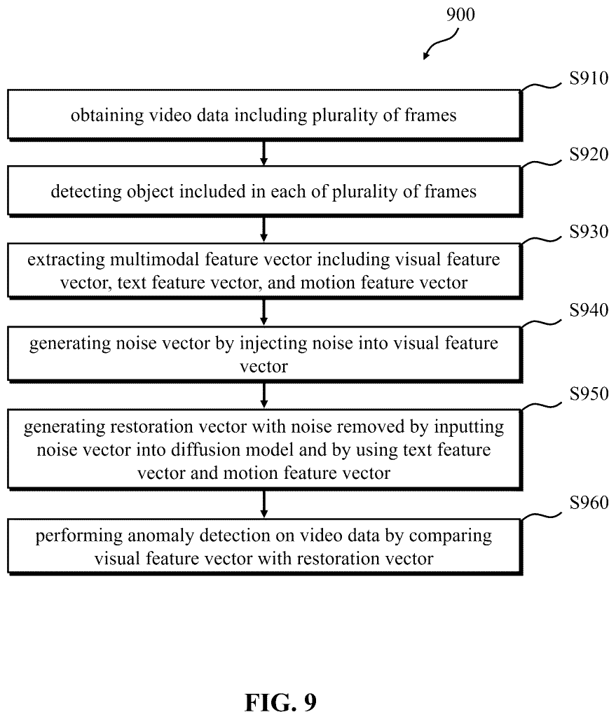

FIG. 9 is a flowchart illustrating an example of a method 900 for detecting a video anomaly on the basis of multimodal diffusion according to the exemplary embodiments of the present disclosure. The method 900 for detecting the video anomaly on basis of the multimodal diffusion may be performed by a processor (e.g., at least one processor of the computing device). In step S910, the method 900 for detecting the video anomaly on basis of the multimodal diffusion may be initiated by the processor obtaining video data including a plurality of frames. For example, the video data may be obtained from a surveillance camera such as CCTV, but is not limited thereto.

According to the exemplary embodiments, in step S920, the processor may detect an object included in each of the plurality of frames. For example, the processor may detect the object included in each of the plurality of frames by using any object detection algorithm and/or machine learning model. Ten, in step S930, the processor may extract a multimodal feature vector including a visual feature vector, a text feature vector, and a motion feature vector for the detected object.

According to the exemplary embodiments, the processor may provide information related to the detected object to a trained I3D-based model, so as to extract the visual feature vector for the object. Additionally or alternatively, the processor may provide information related to the detected object to a BERT-based model to generate a caption describing the object, and provide the generated caption to the trained SimCSE-based model to extract the text feature vector corresponding to the description of the object. Additionally or alternatively, the processor may provide information related to the detected object to a trained HRNet-based model to extract skeletal information corresponding to the object and extract the motion feature vector representing the motion of the object by using the extracted skeletal information.

According to the exemplary embodiments, in step S940, the processor may generate a noise vector by injecting noise into the visual feature vector. For example, the processor may generate the noise vector by injecting an amount of Gaussian noise determined according to a range of a time step into the visual feature vector. Here, the noise vector refers to a vector in which at least some noise has been injected into the visual feature vector, and may include both a vector initially generated by a diffusion process and a vector that has not sufficiently passed through a diffusion model and thus still has the remaining noise.

According to the exemplary embodiments, in step S950, the processor may input a noise vector into a diffusion model and generate a restoration vector with removed noise by using the text feature vector and the motion feature vector as conditions. Here, the diffusion model may include a first diffusion model and a second diffusion model. The processor may generate the restoration vector with the noise removed by iteratively performing: a first restoration step of inputting a noise vector into the first diffusion model and removing at least some noise included in the noise vector by using the text feature vector as a condition; and a second restoration step of inputting noise into the second diffusion model and removing at least some of the noise included in a noise vector by using the motion feature vector as a condition.

According to the exemplary embodiments, in step S960, the processor may perform anomaly detection on the video data by comparing the visual feature vector and the restoration vector. In this case, the processor may calculate an anomaly score based on a distance between the visual feature vector and the restoration vector, and perform the anomaly detection on the video data on the basis of whether the calculated anomaly score is greater than or equal to a threshold value. For example, the anomaly score may be calculated by using a mean squared error between the visual feature vector and the reconstruction vector.

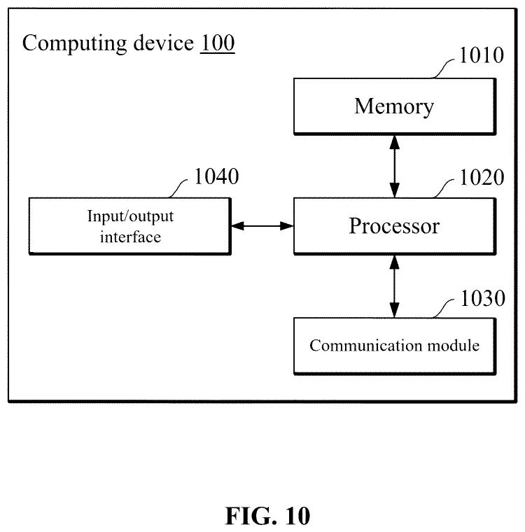

FIG. 10 is a block diagram illustrating a hardware configuration of the computing device 100 according to the exemplary embodiments of the present disclosure. The computing device 100 may include a memory 1010, a processor 1020, a communication module 1030, and an input/output interface 1040. As shown in FIG. 10, the computing device 100 may be configured to communicate information and/or data through a network by using the communication module 1030.

The memory 1010 may include any non-transitory computer-readable recording medium. According to the exemplary embodiments, the memory 1010 may include a permanent mass storage device such as a random access memory (RAM), a read only memory (ROM), a disk drive, a solid state drive (SSD), and a flash memory. As another example, the permanent mass storage device such as the ROM, SSD, flash memory, and disk drive may be included in the computing device 100 as a separate permanent storage device distinguished from the memory. In addition, an operating system and at least one program code may be stored in the memory 1010.

Such software components may be loaded from the computer-readable recording medium as a separate medium distinguished from the memory 1010. Such separate computer-readable recording medium may include a recording medium directly connectable to such a computing device 100, and may include, for example, the computer-readable recording medium such as a floppy drive, a disk, a tape, a DVD/CD-ROM drive, and a memory card. As another example, the software components may be loaded into the memory 1010 through the communication module 1030 other than the computer-readable recording medium. For example, at least one program may be loaded into the memory 1010 on the basis of a computer program installed through a file provided by developers or a file distribution system distributing an installation file of an application through the communication module 1030.

The processor 1020 may be configured to process commands of the computer program by performing fundamental arithmetic, logic, and input/output calculations. The commands may be provided to another user terminal (not shown) or another external system by the memory 1010 or the communication module 1030.

The communication module 1030 may provide a component or function for the user terminal (not shown) and the computing device 100 to communicate with each other through a network, and may provide a component or function for the computing device 100 to communicate with an external system (e.g., a separate cloud system, etc.). For example, control signals, commands, data, and the like provided under the control of the processor 1020 of the computing device 100 may be transmitted to the user terminal and/or the external system through communication modules of the user terminal and/or the external system via the communication module 1030 and the network.

In addition, the input/output interface 1040 of the computing device 100 may be a means for interfacing with a device (not shown) for input or output, the device being connectable to the computing device 100 or included by the computing device 100. In FIG. 10, the input/output interface 1040 is illustrated as a component configured separately from the processor 1020, but is not limited thereto, and the input/output interface 1040 may be configured to be included in the processor 1020. The computing device 100 may include more components than those in FIG. 10. However, there is no need to explicitly illustrate most of the components of the related art.

The processor 1020 of the computing device 100 may be configured to manage, process, and/or store information and/or data received from a plurality of user terminals and/or a plurality of external systems.

The above-described method and/or various exemplary embodiments may be realized by digital electronic circuits, computer hardware, firmware, software, and/or a combination thereof. The various exemplary embodiments of the present disclosure may be executed by data processing devices, for example, one or more programmable processors and/or one or more computing devices, or may be implemented with computer-readable recording media and/or computer programs stored on the computer-readable recording media. The computer programs described above may be written in any types of programming languages, including compiled or interpreted languages, and may be distributed in any types thereof, such as standalone programs, modules, and subroutines. The computer programs may be distributed through a single computing device, a plurality of computing devices connected through the same network, and/or a plurality of computing devices distributed so as to be connected through a plurality of different networks.

The above-described method and/or various exemplary embodiments may be performed by one or more processors configured to execute one or more computer programs that process, store, and/or manage any feature, function, and the like by operating on the basis of input data or generating output data. For example, the method and/or various exemplary embodiments of the present disclosure may be performed by a special purpose logic circuit such as a Field Programmable Gate Array (FPGA) or an Application Specific Integrated Circuit (ASIC), and the device and/or the system for performing the method and/or exemplary embodiments of the present disclosure may be implemented by using the special purpose logic circuits such as the FPGA or ASIC.

The one or more processors for executing the computer programs may include general purpose or special purpose microprocessors and/or one or more processors of any type of digital computing device. Each processor may receive commands and/or data from each of the read-only memory and random access memory, or may receive commands and/or data from all the read-only memory and random access memory. In the present disclosure, the components of the computing device for performing the method and/or exemplary embodiments may include one or more processors for executing the commands, and one or more memory devices for storing the commands and/or data.

According to the exemplary embodiments, the computing device may exchange data with one or more mass storage devices for storing data. For example, the computing device may receive data from a magnetic disc or an optical disc, and may transmit data to the magnetic disc or the optical disc. The computer-readable storage medium suitable for storing the commands and/or data associated with the computer programs may include, but is not limited to, any type of non-volatile memory including semiconductor memory devices such as Erasable Programmable Read-Only Memory (EPROM), Electrically Erasable PROM (EEPROM), and flash memory devices. For example, the computer-readable storage medium may include: the magnetic disk such as an internal hard disk or a removable disk; a magneto-optical disk; a CD-ROM; and a DVD-ROM disk.

To provide interaction with a user, a computing device may include, but is not limited to, a display device (e.g., a Cathode Ray Tube (CRT), a Liquid Crystal Display (LCD), etc.) for providing or displaying information to the user, and a pointing device (e.g., a keyboard, a mouse, a trackball, etc.) for allowing the user to provide input and/or commands, and the like to the computing device. That is, the computing device may further include any other type of device for providing the interaction with the user. For example, for the interaction with the user, the computing device may provide any form of sensory feedback including visual feedback, auditory feedback, and/or tactile feedback to the user. In this regard, the user may provide the input to the computing device through various gestures of vision, voice, motion, etc.

In the present disclosure, the various exemplary embodiments may be implemented in a computing system including a backend component (e.g., a data server), a middleware component (e.g., an application server), and/or a frontend component. In this case, the components may be interconnected by any form or medium of digital data communication, such as a communication network. For example, the communication network may include a Local Area Network (IAN), a Wide Area Network (WAN), etc.

The computing device based on the exemplary embodiments described in the present specification may be implemented by using hardware and/or software configured to interact with a user, including a user device, a user interface (UI) device, a user terminal, or a client device. For example, the computing device may include a portable computing device such as a laptop computer. Additionally or alternatively, the computing device may include, but is not limited to, a personal digital assistant (PDA), a tablet PC, a game console, a wearable device, an internet of things (IoT) device, a virtual reality (VR) device, an augmented reality (AR) device, etc. The computing device may further include other types of devices configured to interact with the user. In addition, the computing device may include a portable communication device (e.g., a mobile phone, a smartphone, a wireless cellular phone, etc.) suitable for wireless communication over a network, such as a mobile communication network. The computing device may be configured to communicate wirelessly with a network server by using wireless communication technologies and/or protocols, such as Radio Frequency (RF), Microwave Frequency (MWF), and/or Infrared Ray Frequency (IRF).

The various exemplary embodiments including specific structural and functional details in the present disclosure are exemplary. Therefore, the exemplary embodiments of the present disclosure are not limited to those described above and may be implemented in various other forms. In addition, the terminology used in the present disclosure is for the purpose of describing some exemplary embodiments, and is not to be construed as limiting the exemplary embodiments. For example, words and the terms in singular form described above may be interpreted as to include those in plural form as well, unless the context clearly indicates otherwise.

In the present disclosure, unless otherwise defined, all terms used in the present specification, including technical or scientific terms, have the same meaning as commonly understood by those skilled in the art to which such concepts belong. In addition, commonly used terms, such as terms defined in dictionaries, should be interpreted to have a meaning consistent with their meaning in the context of the related art.

Although the present disclosure has been described in relation to some exemplary embodiments in the present specification, various modifications and changes may be made without departing from the scope of the embodiments of the present disclosure that may be understood by those skilled in the art to which the embodiments of the present disclosure pertains. Furthermore, such modifications and changes should be considered to fall within the scope of the claims appended to the present specification.

What is claimed is:

1. A method of detecting a video anomaly and being performed by at least one processor, the method comprising:
obtaining video data comprising a plurality of frames;
detecting an object included in each of the plurality of frames;
extracting a multimodal feature vector including a visual feature vector, a text feature vector, and a motion feature vector for the detected object;
generating a noise vector by injecting noise into the visual feature vector;
generating a restoration vector with the noise removed by inputting the noise vector into a diffusion model and using the text feature vector and the motion feature vector as conditions; and
performing anomaly detection on the video data by comparing the visual feature vector and the restoration vector.

2. The method of claim 1, wherein the extracting of the multimodal feature vector comprises:
extracting the visual feature vector for the object by providing information related to the detected object to a trained model based on Inflated 3D ConvNet (I3D).

3. The method of claim 1, wherein the extracting of the multimodal feature vector comprises:
generating a caption for describing the object by providing information related to the detected object to a model based on Bidirectional Encoder Representations from Transformers (BERT); and
extracting the text feature vector corresponding to the description of the object by providing the generated caption to a trained model based on Simple Contrastive Learning of Sentence Embeddings (SimCSE).

4. The method of claim 1, wherein the extracting of the multimodal feature vector comprises:
extracting skeletal information corresponding to the object by providing information related to the detected object to a trained model based on High-Resolution Network (HRNet); and
extracting the motion feature vector representing motion of the object by using the extracted skeletal information.

5. The method of claim 4, wherein the extracting of the motion feature vector representing the motion of the object by using the extracted skeletal information comprises:
extracting the motion feature vector by providing the extracted skeletal information to a trained model based on PoseConv3D.

6. The method of claim 1, wherein the generating of the noise vector by injecting the noise into the visual feature vector comprises:
generating the noise vector by injecting an amount of Gaussian noise determined according to a range of a time step into the visual feature vector.

7. The method of claim 1, wherein the diffusion model includes a first diffusion model and a second diffusion model, and
the generating of the restoration vector with the noise removed comprises:
a first restoration step of inputting the noise vector into the first diffusion model and removing at least some of the noise included in the noise vector by using the text feature vector as a condition; and
a second restoration step of inputting a noise vector into the second diffusion model and removing at least some of the noise included in the noise vector by using the motion feature vector as a condition.

8. The method of claim 7, wherein the generating of the restoration vector with the noise removed further comprises:
generating the restoration vector with the noise removed by iteratively performing the first restoration step and the second restoration step.

9. The method of claim 1, wherein the performing of the anomaly detection on the video data comprises:
calculating an anomaly score based on a distance between the visual feature vector and the restoration vector, and
performing the anomaly detection on the video data on the basis of whether the calculated anomaly score is greater than or equal to a threshold value.

10. The method of claim 9, wherein the calculating of the anomaly score comprises:
calculating the anomaly score according to the distance by using a mean square error (MSE) between the visual feature vector and the restoration vector.

11. The method of claim 1, wherein the diffusion model comprises:
an encoder comprising a plurality of denoising attention blocks (DABs);
a bottleneck; and
a decoder.

12. The method of claim 11, wherein each denoising attention block comprises:
a residual block comprising a plurality of linear layers connected by skip connection; and
a transformer block comprising a self-attention layer, a cross-attention layer, and a feed-forward network (FFN).

13. A non-transitory computer readable recording medium storing computer program to execute a method of detecting a video anomaly on a computer according to claim 1.

14. A computing device comprising:
a communication module;
a memory; and
at least on processor connected to the memory and configured to execute at least one computer-readable program comprised in the memory,
wherein the at least one program comprises:
commands that obtain video data including a plurality of frames, detect an object included in each of the plurality of frames, extract a multimodal feature vector including a visual feature vector, a text feature vector, and a motion feature vector for the detected object, generate a noise vector by injecting noise into the visual feature vector, generate a restoration vector with the noise removed by inputting the noise vector into a diffusion model and using the text feature vector and the motion feature vector as conditions, and perform anomaly detection on the video data by comparing the visual feature vector and the restoration vector.
